(19) United States
(12) Patent Application Publication
(10) Pub. No.: US 2008/0190554 A1
(43) Pub. Date: Aug. 14, 2008

(54) Method of Decorating an Article and Equipment for Implementing Said Method

(75) Inventor: Jean-Noel Claveau, Coisia (FR)

Correspondence Address: BLANK ROME LLP, 600 NEW HAMPSHIRE AVENUE, N.W., WASHINGTON, DC, 20037, US

(73) Assignee: DMTS, Ceyzeriat (FR)

(21) Appl. No.: 10/562,313

(22) PCT Filed: Jun. 24, 2004
(86) PCT No.: PCT/FR2004/001599

§ 371 Date: Apr. 8, 2008

(30) Foreign Application Priority Data
Jun. 26, 2003 (FR) 03/50259
Jul. 8, 2003 (FR) 03/08343

(51) Int. Cl. B32B 38/14

(52) U.S. Cl. 156/277

(57) ABSTRACT

A method of decorating an article. The method includes preparing a transfer sheet by printing same with at least one heat-activated substance and transferring the heat-activated substance to the article by applying said transfer sheet to the article to form an assembly and heating the assembly, wherein heating is performed by quenching the assembly in a non-ferrous metal alloy bath, which is maintained at a nominal temperature for the activation of said heat-activated substance.

The invention relates to the decoration of articles by transferring heat-activated substances, such as heat-activated inks, in particular sublimable inks or even gilding substances.

The general principle is known through several patents of the previous technique, and in particular patents registered by the patentee.

European patent EP0451067 relates to a method of decorating the surface of an object by transferring a decoration with the help of a machine comprising two linked frames in which one of the sides is solidly attached to an elastically deformable membrane with a view to forming a watertight enclosure, of the type that consists of:
having at least one object, in any shape whatsoever on the support sheet in contact with the decoration;
covering the object with another support sheet so that the decorated side is in contact with said object;
hermetically sealing the enclosure, characterised in that this consists of:
gluing a layer of insulating material onto the side of each support sheet opposite its decoration;
placing the support sheet so that its decorated side faces outwards;
having at least one object on the support sheet and, more particularly, on the decoration to be transferred;
covering the object with a second support sheet, so that the decorated side is in contact with said object;
inserting the support-sheet and object assembly in a hermetic enclosure;
creating a vacuum in the enclosure;
and inserting the enclosure in an oven adjusted to a determined temperature in order for the decorated sides of the support sheets penetrate by sublimation in the mass of the object.

European patent EP0606189 describes a machine for sublimating a decoration on objects with any shape whatsoever, of the type that comprises two linked frames in which one of the sides is solidly attached to an elastically deformable membrane, characterised in that at least one of the deformable membranes has pre-shaped pockets that can fully house each of the said objects to be decorated.

European patent EP0544603 describes a method of decorating the surface of an object by ink sublimation, characterised in that it consists of:
using as a support for the sublimable ink a material that is sufficiently stretchable and permeable to air so as to be able to adapt to the shape of the object to be decorated without any risk of damaging the decoration to be sublimated;
surrounding the object with the ink support so that all its sides are covered;
and placing the assembly in a machine with a known vacuum, which in turn is inserted in a hot place so as to cause the transfer of the decoration onto all the sides of the object to be decorated.

The company L'OREAL, on the other hand, has registered European patent application EP1099569, which provides a method of applying a decoration to an article that comprises steps that consist of: placing a support coated with a sublimable ink in contact with one side of an article; using heating means to heat the support so as to cause the sublimation of the ink and its transfer onto the article, while using cooling means to cool the opposite side of the article.

The company KOLORFUSION has registered patent application PCT WO9962722, which relates to a method that makes it possible to apply a decoration to the surface of an object by means of printing with sublimation ink. In this method, a heat-shrinkable film provided with a decoration in sublimation ink is used as an ink support or as a transfer sheet. In another method that allows a decoration to be applied to the surface of an object by means of printing in sublimation ink, a standard ink support or transfer sheet is used as well as a heat-shrinkable film outer wrapping. The film sheet can be provided with joints so as to form an envelope and a decoration in sublimation ink can possibly be included on the inner surface of the envelope. The object to be decorated is placed inside the film envelope. If using a standard transfer film, this is placed on the object before it is wrapped in the heat-shrinkable film. Before proceeding to print using sublimation ink, the object can be pre-treated by means of a coating on which the decoration will be printed. The film envelope is heated so that the film shrinks and adapts to the surface of the object. The shrinking of the film around the object, when combined with the heat, produces the pressure required for transferring the decoration from the film to the surface or to the coating of the object to be decorated. Once the transfer by sublimation is completed, the film can be left in place as an outer wrapping or else it can be removed together with the standard transfer sheet that may have been used, thus uncovering the freshly decorated object.

The solutions of the previous technique are not entirely satisfactory since they require many delicate manipulations in order to perform an accurate transfer, particularly when the article receiving the transfer is fragile or has a complex shape. The heating required for sublimation of the ink requires rather long heating times, which lead to overheating of the article to be decorated. This is not very suitable for fragile articles, or articles that are made from heat-sensitive materials.

The object of this invention is to remedy the disadvantages of the solutions of the previous technique by providing an improved method and improved equipment.

For this purpose, the invention relates, according to its most general aspect, to a method of decorating an article comprising a step that consists of preparing a transfer sheet by printing it with at least one heat-activated ink, a transfer step consisting of applying said sheet to the article to be decorated, and then heating the assembly, characterised in that the heating is performed by quenching the article to be decorated, which is associated with the transfer sheet, in a non-ferrous metal alloy bath maintained at a nominal temperature for the activation of the heat-activated ink.

According to a first alternative, the bath is made up of an alloy containing antimony, tin, bismuth and lead.

According to a second alternative, the bath is made up of an alloy containing bismuth, lead, tin and cadmium.

According to a third alternative, the bath is made up of a non-ferrous metal alloy containing bismuth.

The article to be decorated is advantageously enclosed in a flocked material on which an image is printed using at least one heat-activated ink.

According to a preferred embodiment of the invention, said heat-activated ink is a sublimable ink.

According to an alternative, the heat-activated ink is of the “thermofusible” type.

According to an advantageous embodiment of the invention, the method comprises a transfer step, in which the transfer sheet forms a watertight envelope around the article to be decorated, connected to a depression spring.

The heating in order to activate the ink during the transfer step is preferably provided by means of immersion in an alloy consisting of bismuth, lead, tin and cadmium (Bi 50%, Pb 25%, Sn 12.5%, Cd 12.5%), which has a melting point of around 70° C., maintained at a temperature of around 190° C.

The invention also relates to equipment for implementing the method, characterised in that it comprises a vat equipped with a thermostat and containing a bath of a non-ferrous metal alloy.

The invention will be understood better from reading the following description of non-exhaustive examples of implementation.

The transfer sheet for implementing the method advantageously consists of:
a Teflon film
a sheet of transfer paper used for decorating a fabric by sublimation
a sheet of backing paper
a flocked glue
made from a flocked elastomer
made from a flocked natural latex
made from a flocked synthetic latex
a sheet of flocked natural polyisoprene.

The flocks consist of:
cotton fibres
viscose fibres
polyamide fibres
acrylic fibres
polyester fibres.

The decoration of an article requires a succession of operations. The first operation consists of preparing a blank transfer support.

The transfer support is an elastomer, resistant to the temperatures required for sublimation of the ink. This can be a sheet of natural or synthetic latex (neoprene, nitrile rubber), PVC (polyvinyl chloride) or vinyl. These components can be mixed in order to optimise their resistance.

It can also consist of a synthetic polymer which has been given characteristics that are similar to those of natural latex by means of vulcanisation, and resulting from the combination of several monomers: acrylonitrile, butadiene and, possibly, carboxylic acid with zinc oxide.

It can also consist of a synthetic high-performance elastomer obtained by polymerisation of a chlorinated compound: polychloroprene.

This membrane is flocked by a method that consists of placing a film of glue on the surface of the membrane and then placing short textile fibres on the glued surface.

The film thus prepared enables printing with sublimable ink, by means of a traditional image-transfer method, such as photogravure, silk-screen printing or simply printing with an inkjet printer.

The image, digitised and processed by a computer, is printed with a special sublimable ink in a professional inkjet printer or any other ad hoc printing equipment.

Sublimable inks consist generally of molecules that are modest in terms of size and mass, with a compromise between the existence of conjugated double bonds and conjugated cycles that enables the molecules to be coloured and the molecular masses to be reduced so that the molecules are compatible with the sublimation process.

It is also possible, when printing the transfer sheet, to use phase-change inks and, more particularly, thermofusible inks.

The printed transfer sheet is then applied to the article to be decorated.

It preferably surrounds the article in a watertight fashion so as to form a watertight envelope inside which a vacuum is created. The sheet surrounding the article to be decorated is connected for this purpose, by means of a tube, to a vacuum pump or to a depression spring, so as to assure that the printed surface is applied against the surface of the article to be decorated.

The flocked fibres form a porous cavity that allows the passage of air when the depression is applied. The lack of a structure in the flocking stops the article from being marked with a raster, as was the case with the previous technique.

Next, the assembly is heated to a compatible temperature and duration required for transferring the heat-activated ink.

In the absence of indications supplied by the distributor of the heat-activated ink, the skilled worker will know, by means of simple routine tests, how to determine the optimum conditions. For this, an initial temperature and duration will be selected, for example 180° for 2 seconds, and this will be increased by regular amounts, for example, by 5° C. and 0.5 seconds, until a plateau is reached in the quality of the transfer.

The heating can be assured by a flow of hot air or by immersion in a hot liquid.

The assembly formed by the transfer sheet and the article to be decorated is advantageously plunged into a bath of a nonferrous-metal alloy with a low melting point. This can be, for example, an alloy consisting of bismuth, lead, tin and cadmium (Bi 50%, Pb 25%, Sn 12.5%, Cd 12.5%), which has a melting point of around 70° C., maintained at a temperature of around 190° C.

The method is also intended for the transfer of heat-activated substances such as sheets of gold or metal alloys. In this case, the substrate consists of a backing paper. The heat-activated substance consists, for example, of a heat-activated glue that comprises pigments or metal powders. This solution makes it possible to proceed with hot stamping or transferring of a metal film onto an object, in particular a bottle.

The invention can also be implemented for decorating a wire, for example a cable or an electrical wire. In this case, the wire can come into contact with the transfer sheet made in the form of a strip. The wire passes through a system of rollers placed upstream and downstream from the bath.

The transfer sheet also passes through a system of rollers placed upstream and downstream from the bath. The wire and the transfer strip come into contact upstream from the bath to be plunged together into the heating bath, in which there is a roller that guides them through this bath.

The transfer takes place inside the bath, and the decorated wire comes out of the bath and is wound onto a reel.

1. A method of decorating an article comprising:
preparing a transfer sheet by printing same with at least one heat-activated substance, and
transferring the heat-activated substance to the article by applying said transfer sheet to the article to form an assembly and heating the assembly, wherein heating is performed by quenching the assembly in a non-ferrous metal alloy bath, which is maintained at a nominal temperature for the activation of said heat-activated substance.

2. The method of decorating an article according to claim 1, wherein the bath includes an alloy comprising antimony, tin, bismuth and lead.

3. The method of decorating an article according to claim 1, wherein the bath includes an alloy comprising bismuth, lead, tin and cadmium.

4. The method of decorating an article according to claim 1, wherein the bath includes a non-ferrous metal alloy comprising bismuth.

5. The method of decorating an article according to claim 1, wherein the article is enclosed in a film of Teflon on which an image is printed using at least one heat-activated substance.

6. The method of decorating an article according to claim 1, wherein the article is enclosed in a sheet of backing paper on which an image is printed using at least one heat-activated substance.

7. The method of decorating an article according to claim 1, wherein the article is enclosed in a sheet of transfer paper on which an image is printed using at least one heat-activated substance.

8. The method of decorating an article according claim 1, wherein the article is enclosed in a flocked material on which an image is printed using at least one heat-activated substance.

9. The method of decorating an article according claim 1, wherein said heat-activated substance is a sublimable ink.

10. The method of decorating an article according claim 1, wherein the heat-activated substance is an ink of the “thermofusible” type.

11. The method of decorating an article according claim 1, wherein the heat-activated substance is a gold leaf.

12. The method of decorating an article according claim 1, wherein the transfer sheet forms a watertight envelope around the article to be decorated, which is connected to a depression spring, during the step of transferring the heat-activated substance to the article.

13. The method of decorating an article according to claim 1, wherein the bath includes a non-ferrous metal alloy consisting of bismuth, lead, tin and cadmium (Bi 50%, Pb 25%, Sn 12.5%, Cd 12.5%), which has a melting point of around 70° C., maintained at a temperature of around 190° C.

14. The method of decorating an article according to claim 1, wherein the transfer sheet comprises a substrate of backing paper.

15. The method of decorating an article according to claim 1, wherein the heat-activated substance includes a heat-activated glue that comprises pigments or metal powders.

16. The method of decorating an article according to claim 1, comprising unwinding a transfer sheet in the form of a strip and of bringing it into contact with a wire to be decorated upstream from the bath.

17. (canceled)
